(19) United States
(12) Patent Application Publication
(10) Pub. No.: US 2016/0129581 A1
(43) Pub. Date: May 12, 2016

(54) HAND TOOL WITH INDICATION PORTION ON HANDLE

(71) Applicants: Tsan-Chang Lee, Taichung (TW); Liang-huei Lin, Taichung (TW)

(72) Inventors: Tsan-Chang Lee, Taichung (TW); Liang-huei Lin, Taichung (TW)

(21) Appl. No.: 14/535,269

(22) Filed: Nov. 6, 2014

(51) Int. Cl. B25G 1/10; B23K 26/362; B23K 26/402; B25B 23/16

(52) U.S. Cl. CPC B25G 1/105; B25B 23/16; B23K 26/362; B23K 26/402; B23K 2203/172

(57) ABSTRACT

A hand tool includes a handle with two heads respectively formed on two ends of the handle. A layer of paint is coated on the handle and has a color that is different from the color of the handle. The layer of paint has at least one hollow portion defined therethrough which can be a character, a digit, a pattern, a specification or a mark. The layer of paint has an anti-slip surface. The layer of paint is first coated on the handle by way of baked coating, and a portion of the layer of paint is removed by way of laser to form the at least one hollow portion. The layer of paint provides better grip feature and desired information of the hand tool.

### BACKGROUND OF THE INVENTION

1. Fields of the invention

The present invention relates to a hand tool, and more particularly, to a hand tool with a layer of anti-slip paint coated on the handle and the layer of anti-slip paint includes indication portion to disclose the size and characters of the hand tool.

2. Descriptions of Related Art

The conventional hand tool 50 is disclosed in FIG. 12 and has a handle 51, two heads 52, 53 are respectively formed on the two ends of the handle 51. The handle 51 has an indication portion 54 formed therein which can be characters, patterns, digits, Trademarks or information of size. However, the handle 51 has a smooth surface which has less friction so that the user cannot hold it firmly when grease is attached on the handle 51. Besides, the indication portion 54 is made by way of pressing and complicated patterns or Trademarks cannot be precisely and clearly pressed. The handle 51 is made of steel which is stiff so that the molds for making the indication portion 54 is easily damaged.

The present invention intends to provide a hand tool that has a layer of anti-slip paint coated on the handle of the hand tool so as to eliminate the shortcomings mentioned above.

### SUMMARY OF THE INVENTION

The present invention relates to a hand tool and comprises a handle having a first head and a second head respectively formed on two ends of the handle. The first head has a first mounting portion, and the second head has a second mounting portion. A first layer of paint is coated on the handle and has a color that is different from the color of the handle. The first layer of paint has at least one hollow portion defined therethrough, and the at least one hole is a character, a digit, a pattern, a specification or a mark. The first layer of paint has an anti-slip surface. The first layer of paint is coated on the handle by way of baked coating, and a portion of the first layer of paint is removed by way of laser to form the at least one hollow portion.

The primary object of the present invention is to provide a hand tool with a layer of paint on the handle thereof so as to provide a larger friction for grip, and the at least one hollow portion provides specification and other features of the hand tool.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view of the hand tool of the present invention;

FIG. 2 is a perspective view to show the hand tool of the present invention;

FIG. 3 is a top view to show the hand tool of the present invention;

FIG. 4 is a perspective view to show the second embodiment of the hand tool of the present invention;

FIG. 5 is an exploded view of the third embodiment of the hand tool of the present invention;

FIG. 6 is a perspective view to show the third embodiment of the hand tool of the present invention;

FIG. 7 is a perspective view to show the fourth embodiment of the hand tool of the present invention;

FIG. 8 is a perspective view to show the fifth embodiment of the hand tool of the present invention;

FIG. 9 is an exploded view of the sixth embodiment of the hand tool of the present invention;

FIG. 10 is a perspective view to show the seventh embodiment of the hand tool of the present invention;

FIG. 11 is a perspective view to show the eighth embodiment of the hand tool of the present invention;

FIG. 12 shows the conventional hand tool.

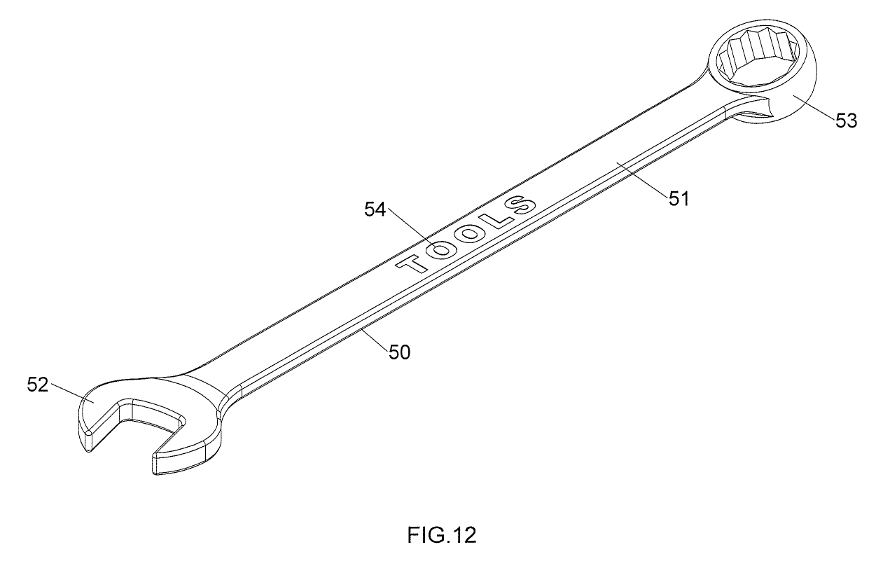

### DETAILED DESCRIPTION OF THE PREFERRED EMBODIMENT

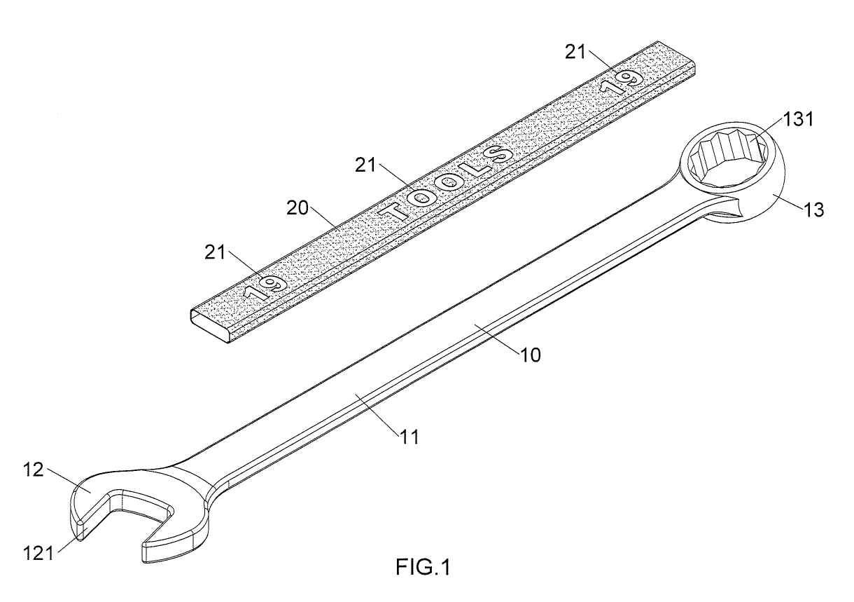

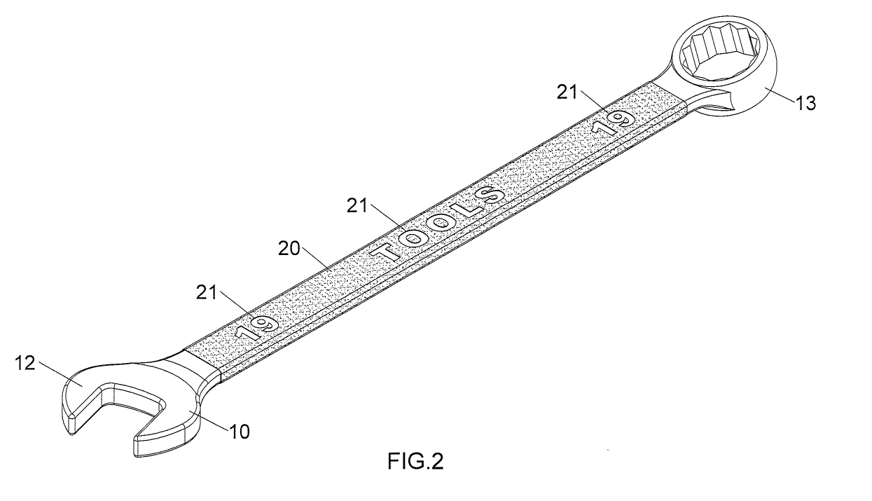

Referring to FIGS. 1 to 2, the hand tool 10 of the present invention is made of steel, aluminum or other proper metal, and comprises a handle 11 which has a first head 12 and a second head 13 respectively formed on the two ends of the handle 11. The first head 12 is an open wrench head and has a first mounting portion 121, and the second head 13 is a box wrench head and has a second mounting portion 131. The first and second heads 12, 13 are used to rotate an object which is not shown.

A first layer of paint 20 is coated on the handle 11 and has a color that is different from the color of the handle 11. The first layer of paint 20 has at least one hollow portion 21 defined therethrough, the at least one hole 21 can be a character, a digit, a pattern, a specification or a mark. The first layer of paint 20 has an anti-slip surface which is easily to be grasped and is non-conductive.

The first head 12, the second head 13 and the handle 11 are covered by a mounting member, and the hand tool 10 is put on a rack. The first layer of paint 20 is coated on the handle 22 by way of baked coating, and a portion of the first layer of paint 20 is removed by way of laser to form the at least one hollow portion 21. A transparent paint can be coated on the first layer of paint 20. Alternatively, the whole hand tool 10 can be coated with a color layer which is coated to the hand tool 10 except for those portions of the hand tool that are coated by the first layer of paint 20. Alternatively, the whole hand tool 10 can be coated with a color layer.

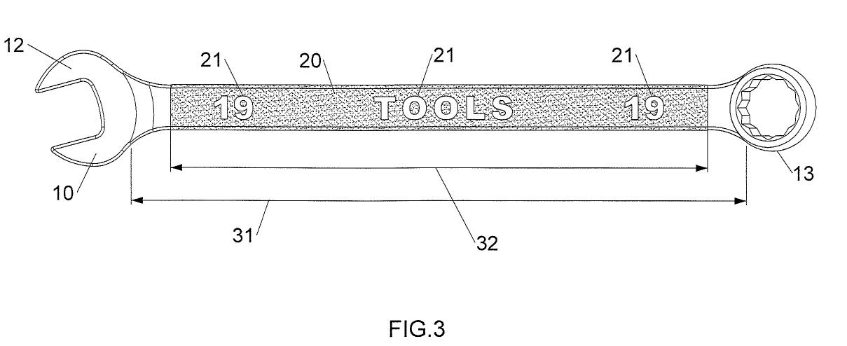

As shown in FIG. 3, the handle 11 has a first length 31, the first layer of paint 20 has a second length 32 which is ½ to 9/10 of the first length 31. Alternatively, the second length 32 is 7/10 to 9/10 of the first length 31.

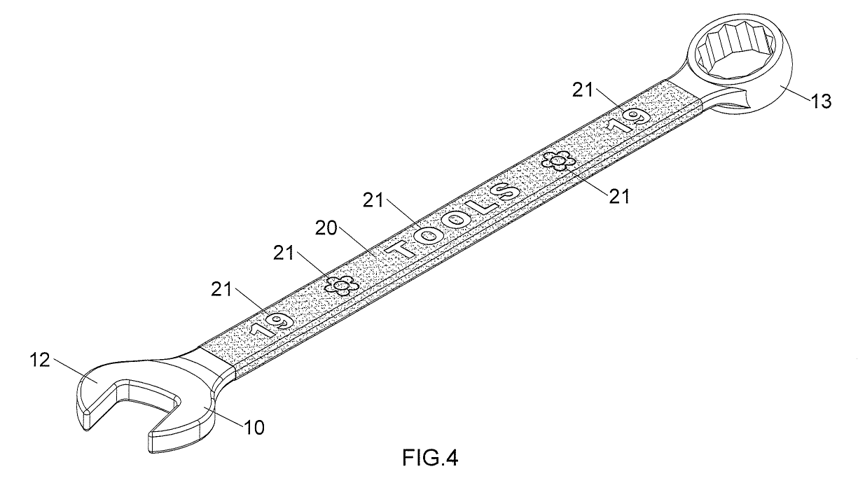

As shown in FIG. 4, a portion of the first layer of paint 20 is removed by way of laser to form the at least one hollow portion 21 which shows the patterns or a Trademark.

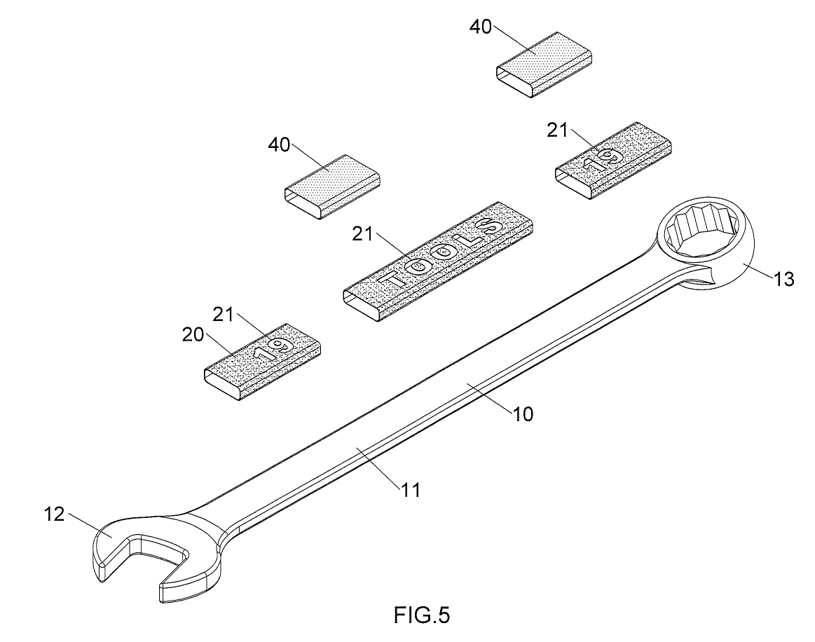

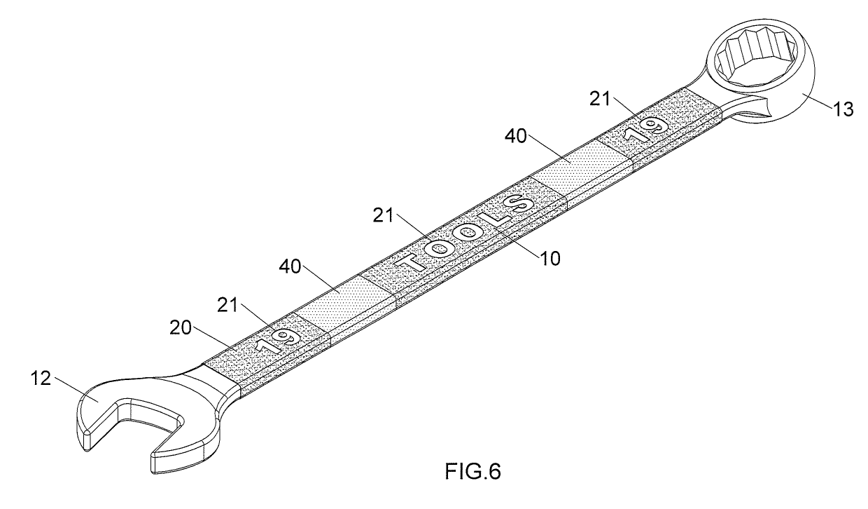

As shown in FIGS. 5 and 6, the first layer of paint 20 includes multiple sections and a second layer of paint 40 is located between two sections of the first layer of paint 20. The first and second layer of paints 20, 40 are different in colors. The first layer of paint 20 has an anti-slip surface, and the second layer of paint 40 can have a smooth surface or a rough surface. The second layer of paint 40 may disclose the Metric system or the English system of the hand tool 10.

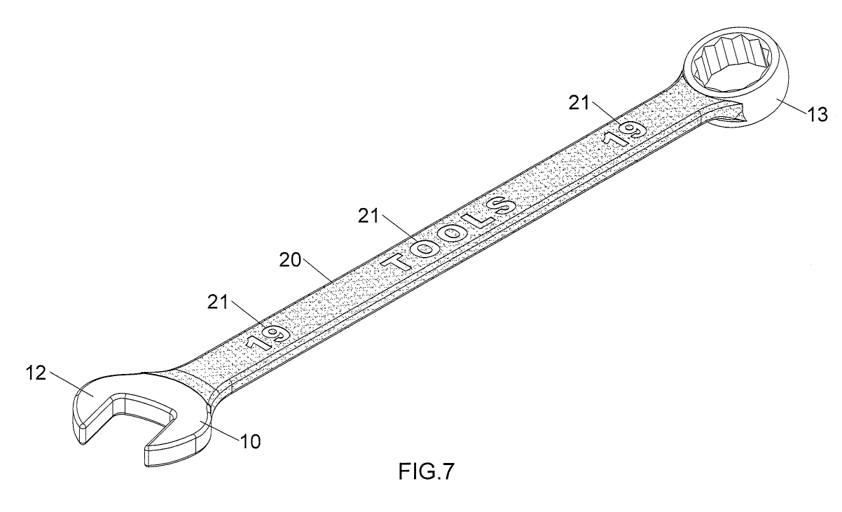

FIG. 7 shows that the first layer of paint 20 is coated on the outside of the handle 11.

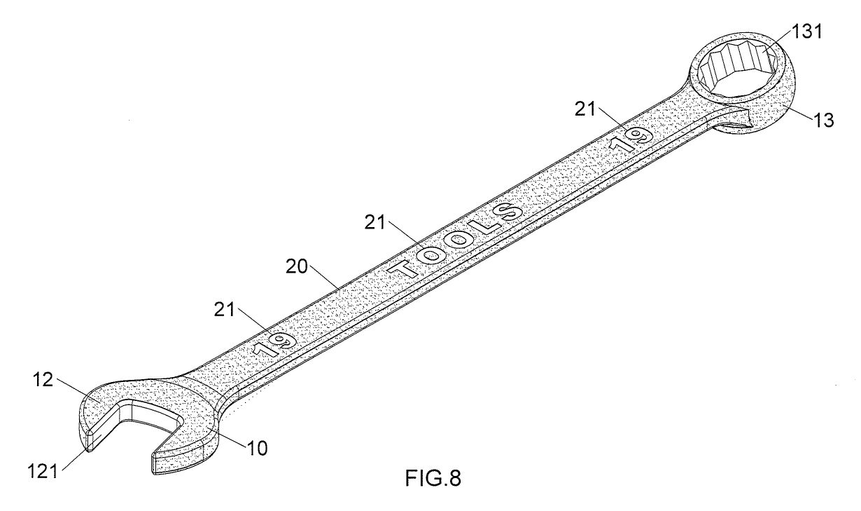

FIG. 8 shows that the first layer of paint 20 is coated on an outside of the hand tool 10 except for the first and second mounting portions 121, 131.

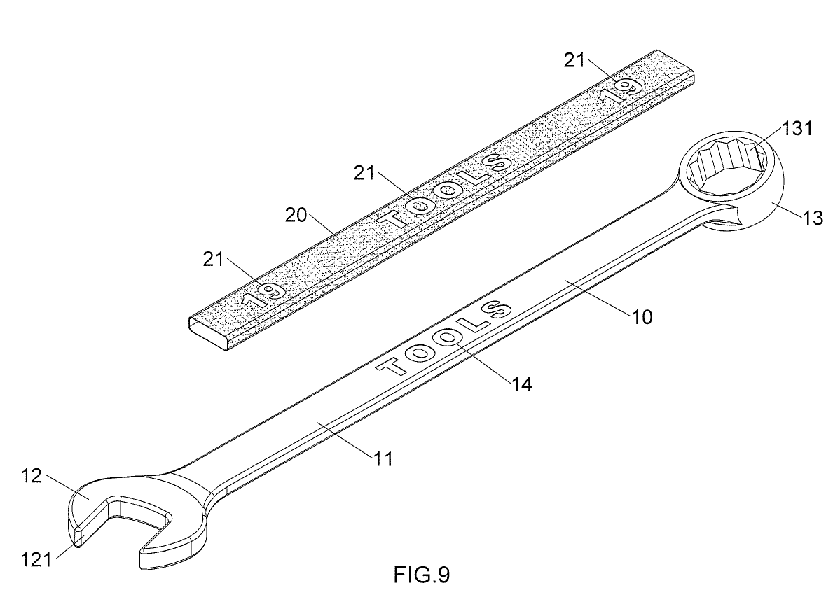

FIG. 9 shows that the handle 11 has an indication portion 14 which is made by way of pressing and can be digits, characters, patterns, specifications or marks. The indication portion 14 is located corresponding to the at least one hollow portion 21 of the first layer of paint 20. The indication portion 14 is a concave portion. Alternatively, the indication portion 14 is a convex portion which extends through the at least one hollow portion 21 and is in flush with a top surface of the first layer of paint 20.

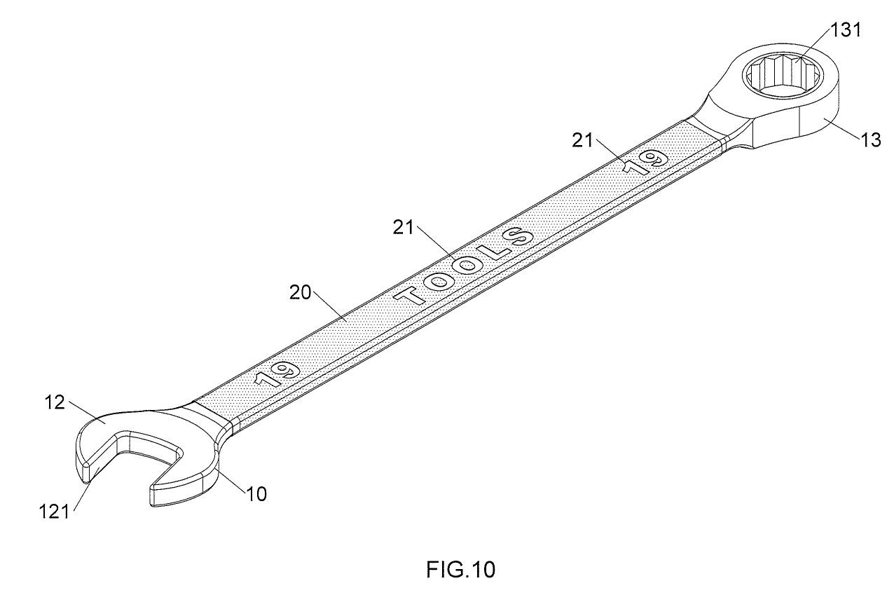

As shown in FIG. 10, the second head 12 is a ratchet driving head, and the first and second heads 12, 13 are used to rotate different sizes of objects.

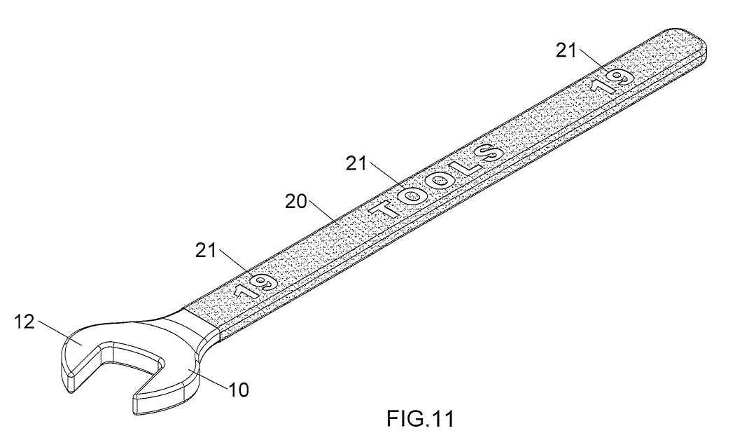

FIG. 11 shows that the hand tool 10 has the first head 11 only.

FIGS. 1, 10 and 11 show that the first layer of paints 20 of the hand tools disclose different specifications and functions.

The first layer of paint 20 has an anti-slip surface and is non-conductive. The flaws of the handle 11 can be covered by the first layer of paint 20, so that there will be not necessary to proceed a secondary treatment. As shown in FIG. 2, the first layer of paint 20 and the handle 11 have different colors so that the characters, the digits, the patterns, the specifications and the marks can be seen via the at least one hollow portion 21. As shown in FIG. 4, the at least one hollow portion 21 is made by removing a portion of the first layer of paint 20 by way of laser so that the hand tool has a neat outer appearance. As shown in FIG. 6, the first and second layer of paints 20, 40 have different colors, the color of the second layer of paint 40 provides another information of the hand tool 10.

While we have shown and described the embodiment in accordance with the present invention, it should be clear to those skilled in the art that further embodiments may be made without departing from the scope of the present invention.

What is claimed is:

1. A hand tool comprising:
a handle having a first head and a second head respectively formed on two ends of the handle, the first head having a first mounting portion, the second head having a second mounting portion;
a first layer of paint coated on the handle and having a color that is different from a color of the handle, the first layer of paint having at least one hollow portion defined therethrough, the at least one hole being a character, a digit, a pattern, a specification or a mark, the first layer of paint having an anti-slip surface, and
the first layer of paint being coated on the handle by way of baked coating, a portion of the first layer of paint being removed by way of laser to form the at least one hollow portion.

2. The hand tool as claimed in claim 1, wherein the handle has a first length, the first layer of paint has a second length which is ½ to 9/10 of the first length.

3. The hand tool as claimed in claim 1, wherein the handle has a first length, the first layer of paint has a second length which is 7/10 to 9/10 of the first length.

4. The hand tool as claimed in claim 1, wherein the first layer of paint includes multiple sections and a second layer of paint is located between two sections of the first layer of paint.

5. The hand tool as claimed in claim 4, wherein the first and second layer of paints are different in colors.

6. The hand tool as claimed in claim 1, wherein the first layer of paint is coated on an outside of the handle.

7. The hand tool as claimed in claim 1, wherein the first layer of paint is coated on an outside of the hand tool except for the first and second mounting portions.

8. The hand tool as claimed in claim 1, wherein the handle has an indication portion which is digits, characters, patterns, specifications or marks, the indication portion is located corresponding to the at least one hollow portion of the first layer of paint.

9. The hand tool as claimed in claim 8, wherein the indication portion is a concave portion.

10. The hand tool as claimed in claim 8, wherein the indication portion is a convex portion which extends through the at least one hollow portion and is in flush with a top surface of the first layer of paint.

11. The hand tool as claimed in claim 1, wherein the first layer of paint has a color for disclosure of functions or specifications.

12. The hand tool as claimed in claim 1, wherein a color layer is coated to the hand tool except for a portion of the hand tool that is coated by the first layer of paint.
